(19) United States
(12) Patent Application Publication
(10) Pub. No.: US 2013/0088545 A1
(43) Pub. Date: Apr. 11, 2013

(54) INKJET PRINT HEAD ASSEMBLY

(71) Applicants: Jae Chan PARK, Suwon (KR); Seung Mo Lim, Suwon (KR); Ho Joon Park, Seoul (KR); Seung Joo Shin, Seoul (KR)

(72) Inventors: Jae Chan PARK, Suwon (KR); Seung Mo Lim, Suwon (KR); Ho Joon Park, Seoul (KR); Seung Joo Shin, Seoul (KR)

(73) Assignee: SAMSUNG ELECTRO-MECHANICS CO., LTD., Suwon (KR)

(21) Appl. No.: 13/613,671

(22) Filed: Sep. 13, 2012

(30) Foreign Application Priority Data
Oct. 11, 2011 (KR) 10-2011-0103418

(51) Int. Cl. B41J 2/135

(52) U.S. Cl. 347/44

(57) ABSTRACT

There is provided an inkjet print head assembly. The inkjet print head assembly includes an inkjet print head, and a first coating layer formed on the inkjet print head, and absorbing and radiating heat generated in the inkjet print head.

### CROSS-REFERENCE TO RELATED APPLICATIONS

This application claims the priority of Korean Patent Application No. 10-2011-0103418 filed on Oct. 11, 2011, In the Korean Intellectual Property Office, the disclosure of which is incorporated herein by reference.

### BACKGROUND OF THE INVENTION

1. Field of the Invention

The present invention relates to an inkjet print head assembly, and more particularly, to an inkjet print head assembly which may effectively absorb and radiate heat generated at the time of a printing operation so as to discharge a liquid droplet having a certain size.

2. Description of the Related Art

An inkjet printer may print a mark having a desired shape or color by discharging ink from a cartridge. The inkjet printer has been utilized as a piece of industrial equipment for printing a colored pattern onto a specific product as well as as a piece of office equipment for printing documents.

In general, the inkjet printer may perform a printing operation while moving, in a width direction of a printing medium, a carriage in which an ink cartridge is mounted.

However, in such a printing operation, the carriage is required to be repeatedly laterally moved during a printing process, such that there may be problems in that a printing speed is slow, while noise may be generated during the movement of the carriage.

Due to this reason, an inkjet printer including a plurality of inkjet print heads for improving printing speed has been recently developed and used. The inkjet printer may print across a wide area in a single operation.

However, in a printer including a plurality of inkjet print heads, the magnitude of temperature rise corresponds to an increase in an amount of printing objects in a printing operation. The temperature rise of the inkjet print head may decrease the viscosity of the ink stored in a pressure chamber, such that a size of a liquid droplet discharged from the inkjet print head may be rapidly changed.

Accordingly, there is a demand for developging an inkjet print head which may discharge the liquid droplet having a certain size, regardless of the amount of printing objects in a printing operation, or an assembly including the inkjet print head.

### SUMMARY OF THE INVENTION

An aspect of the present invention provides an inkjet print head assembly in which a size of a liquid droplet is not significantly changed in spite of an increase in temperature due to an increase in an amount of printing objects in a printing operation.

According to an aspect of the present invention, there is provided an inkjet print head assembly, including: an inkjet print head; and a first coating layer formed on the inkjet print head, and absorbing and radiating heat generated in the inkjet print head.

The first coating layer may be formed of a compound including a metal powder.

The first coating layer may be formed of a compound including a polymer component.

The first coating layer may be formed of a compound including an alcohol component.

The first coating layer may be formed of a compound including at least one of silver (Ag) , boron nitride (B₃N₃), zinc oxide (ZnO), aluminum oxide (Al₂O₃), and polyol ester.

The the first coating layer may include 10 wt. % to 15 wt. % of silver, 1 wt. % to 10 wt. % of boron nitride, 1 wt. % to 10 wt. % of zinc oxide, 22 wt. % to 27 wt. % of aluminum oxide, and 50 wt. % to 52 wt. % of polyol ester.

The inkjet print head may include a housing space in which the first coating layer is housed.

The housing space may be partitioned by a plurality of partition walls.

The inkjet print head may include a first substrate having a pressure chamber formed therein, and a second substrate having a nozzle formed therein, the nozzle discharging ink stored in the pressure chamber.

The first coating layer may be formed on a surface of the first substrate.

According to an aspect of the present invention, there is provided an inkjet print head assembly, including: an inkjet print head; a first coating layer formed on the inkjet print head, and absorbing and radiating heat generated in the inkjet print head; and a second coating layer formed on the first coating layer, and including a compound different from that of the first coating layer.

The second coating layer may be formed between the inkjet print head and the first coating layer.

The second coating layer may be formed of room temperature vulcanizing (RTV) silicon.

The first coating layer may be formed of a compound including a metal powder.

The first coating layer may be formed of a compound including a polymer component.

The first coating layer may be formed of a compound including an alcohol component.

The first coating layer may be formed of a compound including at least one of silver (Ag), boron nitride (B₃N₃), zinc oxide (ZnO), aluminum oxide (Al₂O₃), and polyol ester.

The first coating layer may include 10 wt. % to 15 wt. % of silver, 1 wt. % to 10 wt. % of boron nitride, 1 wt. % to 10 wt. % of zinc oxide, 22 wt. % to 27 wt. % of aluminum oxide, and 50 wt. % to 52 wt. % of polyol ester.

### BRIEF DESCRIPTION OF THE DRAWINGS

The patent or application file contains at least one drawing executed in color. Copies of this patent or patent application publication with color drawing (s) will be provided by the Office upon request and payment of the necessary fee. The above and other aspects, features and other advantages of the present invention will be more clearly understood from the following detailed description taken in conjunction with the accompanying drawings, in which:

FIG. 1 is a cross-sectional view illustrating an inkjet print head assembly according to a first embodiment of the present invention;

FIGS. 2 and 3 are graphs illustrating results of a performance test of the inkjet print head assembly illustrated in FIG. 1;

FIGS. 4 and 5 are graphs illustrating heat distribution of an existing inkjet print head assembly;

FIG. 6 is a graph illustrating heat distribution of the inkjet print head assembly according to the first embodiment of the present invention;

FIG. 7 is a cross-sectional view illustrating an inkjet print head assembly according to a second embodiment of the present invention;

FIG. 8 is a graph illustrating results of a performance test of the inkjet print head assembly illustrated in FIG. 7;

FIG. 9 is a plan view illustrating an upper portion of an inkjet print head assembly according to a third embodiment of the present invention; and

FIG. 10 is a plan view illustrating an upper portion of an inkjet print head assembly according to a fourth embodiment of the present invention.

### DETAILED DESCRIPTION OF THE INVENTION

Embodiments of the present invention will now be described in detail with reference to the accompanying drawings.

In the following description of the invention, terms referring to components of the invention are used in consideration of functions of the respective components, and thus will be understood as not being limited to technical components of the invention.

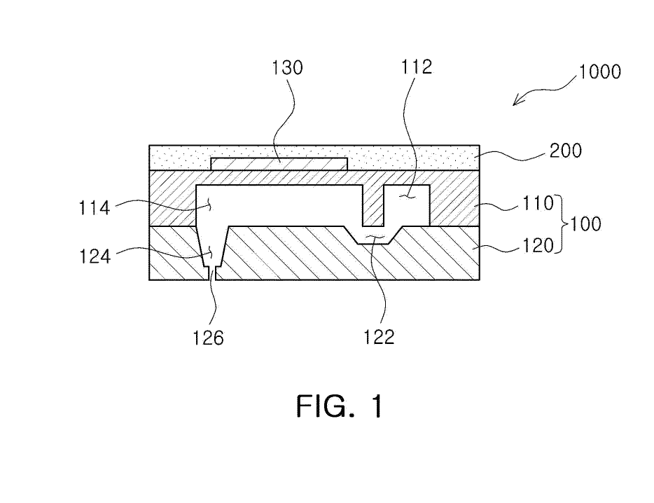

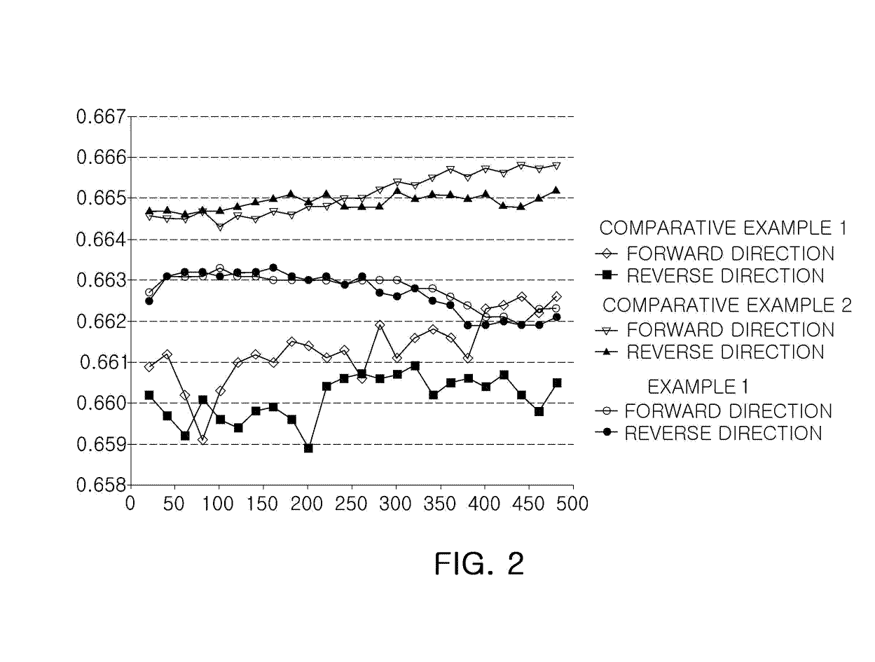

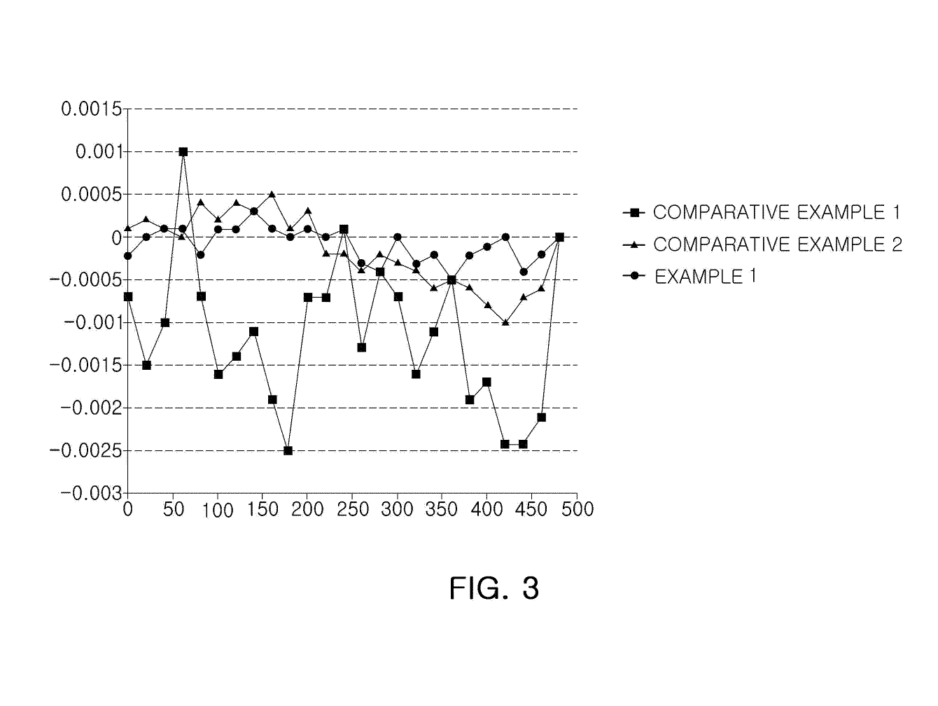

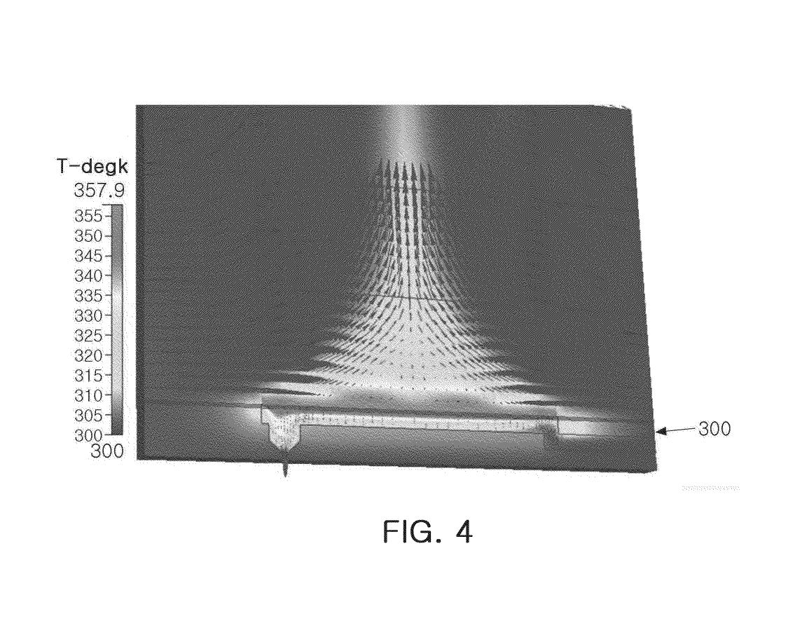

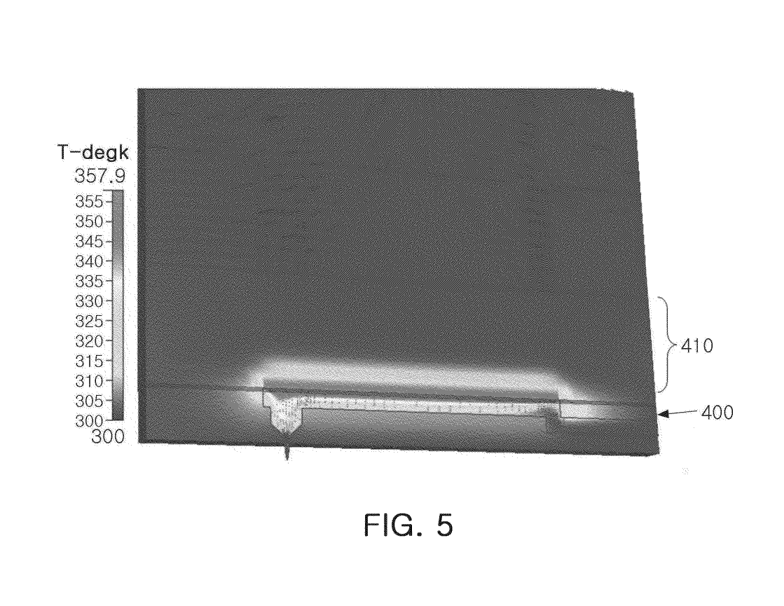

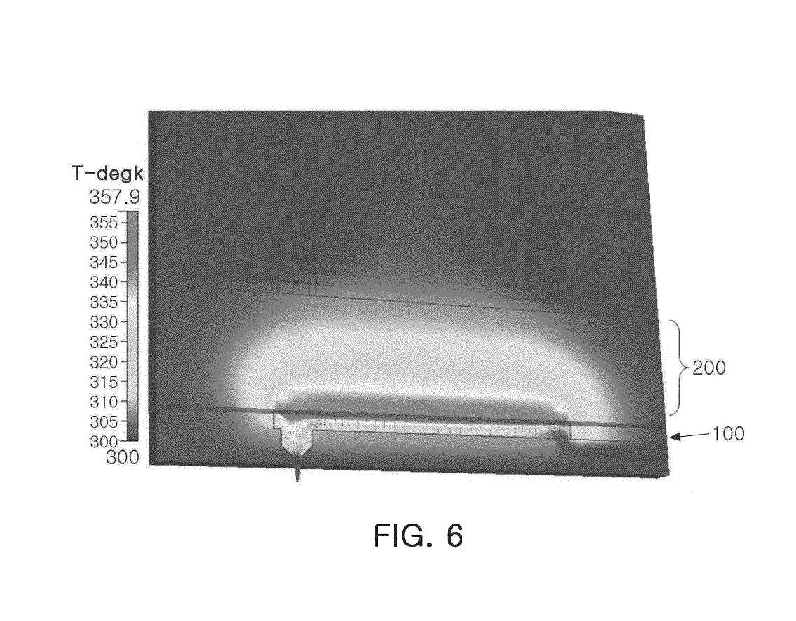

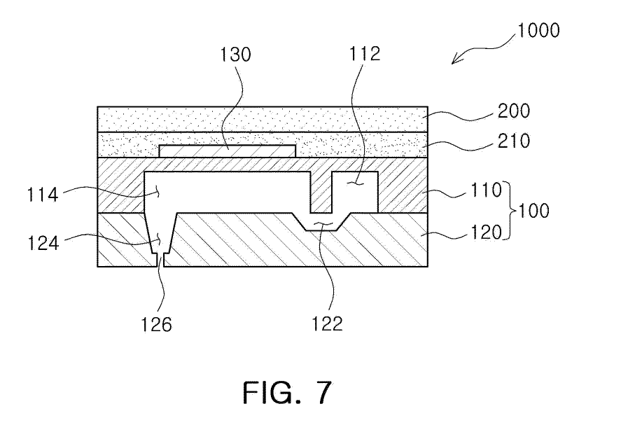

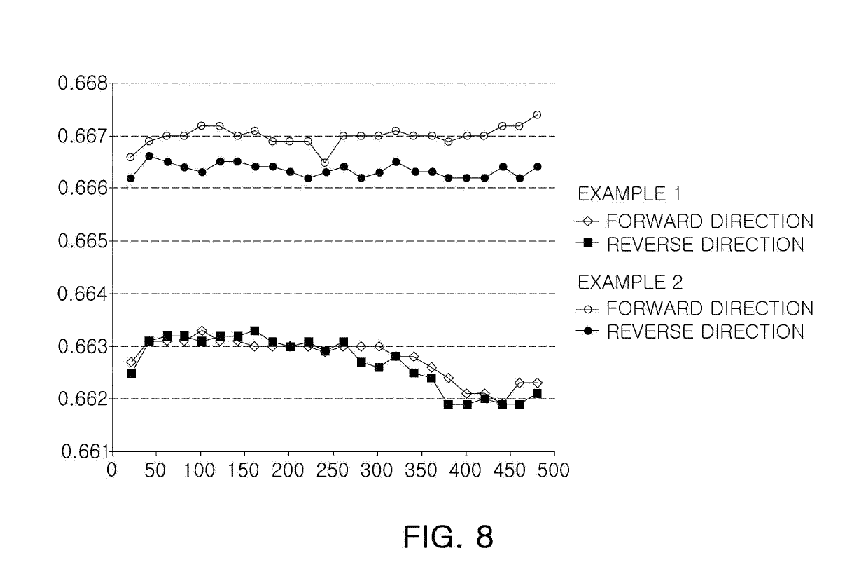

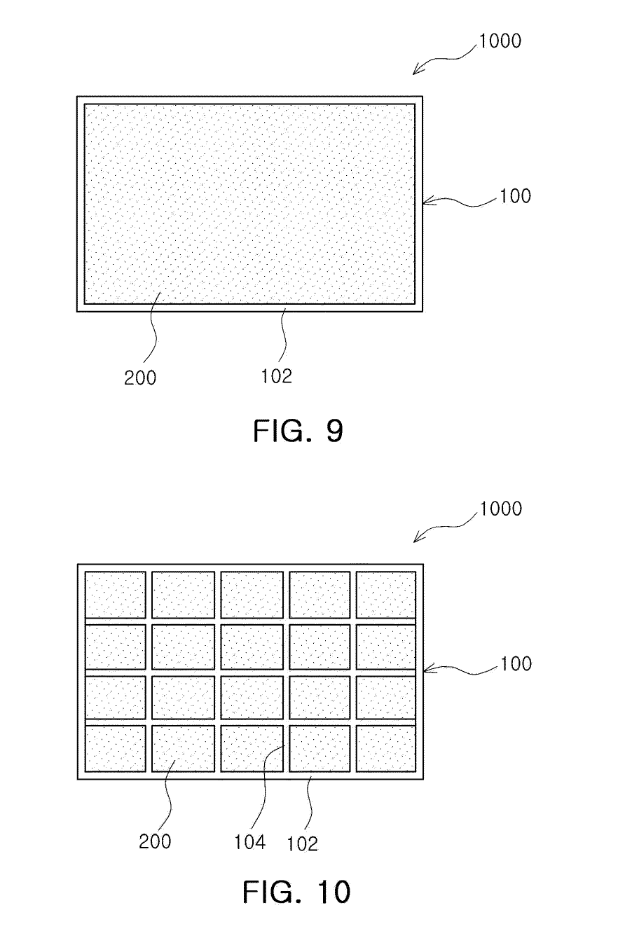

FIG. 1 is a cross-sectional view illustrating an inkjet print head assembly according to a first embodiment of the present invention, FIGS. 2 and 3 are graphs illustrating results of a performance test of the inkjet print head assembly illustrated in FIG. 1, FIGS. 4 and 5 are graphs illustrating heat distribution of an existing inkjet print head assembly, FIG. 6 is a graph illustrating heat distribution of the inkjet print head assembly according to the first embodiment of the present invention, FIG. 7 is a cross-sectional view illustrating an inkjet print head assembly according to a second embodiment of the present invention, FIG. 8 is a graph illustrating results of a performance test of the inkjet print head assembly illustrated in FIG. 7, FIG. 9 is a plan view illustrating an upper portion of an inkjet print head assembly according to a third embodiment of the present invention, and FIG. 10 is a plan view illustrating an upper portion of an inkjet print head assembly according to a fourth embodiment of the present invention.

An inkjet print head assembly 1000 according to a first embodiment of the present invention may include an inkjet print head 100, and a first coating layer 200.

The inkjet print head 100 may include a first substrate 110, a second substrate 120, and a piezoelectric element 130.

The first substrate 110 may be a single-crystal silicon substrate, or an SOI (Silicon on Insulator) wafer in which an insulating layer is formed between two silicon layers. The first substrate 110 may include an ink inlet 112 through which ink flows in, and a pressure chamber 114. For reference, when the first substrate 110 is the SOI wafer, a height of the pressure chamber 114 may be substantially the same as a thickness of the lower silicon layer of the two silicon layers of the SOI wafer.

The piezoelectric element 130 may be formed on the first substrate 110 so as to correspond to the pressure chamber 114.

The piezoelectric element 130 may provide a driving force for discharging the ink flowing into the pressure chamber 114 to a nozzle 126. For example, the piezoelectric element 130 may include a lower electrode that acts as a common electrode, a piezoelectric film that is deformed by the application of a voltage, and an upper electrode that acts as a driving electrode.

The lower electrode may be formed on the entire surface of the first substrate 110, and formed of a single conductive metal material. For example, the lower electrode may include two metallic thin film layers which are formed of titanium (Ti) and platinum (Pt). The lower electrode may act as a diffusion preventing layer preventing mutual diffusion between the piezoelectric film and the first substrate 110, as well as the common electrode. The piezoelectric film may be formed on the lower electrode, and disposed to be located on each of a plurality of pressure chambers 114. The piezoelectric film may be formed of a piezoelectric material, for example, PZT (Lead Zirconate Titanate). The upper electrode may be formed on the piezoelectric film, and formed of at least one material of Pt, Au, Ag, Ni, Ti, Cu, and the like. The upper electrode may be manufactured such that Ag/Pd paste is screen-printed after PZT paste is screen-printed, and the screen-printed pastes are sintered together.

For reference, in the present embodiment, ink is discharged by a piezoelectric driving scheme using the piezoelectric element 130; however, the present invention is not limited or restricted by an ink discharging scheme. The present invention may be configured such that ink is discharged in a variety of schemes such as a thermal driving scheme, and the like according to required conditions.

The second substrate 120 may be a single-crystal silicon substrate, or an SOI wafer. However, the second substrate 120 may have an SOI wafer structure in which the lower silicon layer, the insulating layer, and the upper silicon layer are sequentially stacked. The second substrate 120 may include a manifold 122 transferring the ink flowing into the ink inlet 112 to each of the plurality of pressure chambers 114, a plurality of nozzles 126 discharging the ink therethrough, and a damper 124 formed between the pressure chamber 114 and the nozzle 126. Each of the manifold 122 and the damper 124 may have an inclined side wall, and have a shape in which a horizontal cross-section of each of the manifold 122 and the damper 124 is narrowed from the upper part to the lower part thereof. For reference, in the present specification, the horizontal cross-section may denote a cross-section parallel to an installation surface of the inkjet print head.

A restrictor (not illustrated) for suppressing, from reversely flowing into the manifold 210, the ink in the pressure chamber 114 when the ink is discharged may be formed between the manifold 210 and the pressure chamber 114. Specifically, the restrictor may be formed in a portion where the pressure chamber 114 and the manifold 122 are connected such that it may adjust a flow rate of the ink supplied from the manifold 122 to the pressure chamber 114.

The first coating layer 200 maybe formed on the inkjet print head 100. For example, the first coating layer 200 may be formed on the top of the inkjet print head 100. However, the first coating layer 200 may be formed on a side surface of the inkjet print head 100, as necessary.

The first coating layer 200 may be a compound including a metal powder. For example, the first coating layer 200 may be a compound including a copper powder or an aluminum powder having high thermal conductivity.

Also, the first coating layer 200 may be a compound including a polymer component. Here, the polymer component may surround outer surfaces of particles of the metal powders. The polymer component may minimize the phenomenon that is short-curcuited by the metal powders included in the first coating layer 200. In addition, the polymer component may supress heat absorbed by the metal powder from being rapidly radiated.

Also, the first coating layer 200 may include an alcohol component. The alcohol component may uniformly distribute the metal powder included in the first coating layer 200.

The first coating layer 200 may be a compound including at least one of silver (Ag), boron nitride (B₃N₃), zinc oxide (ZnO), aluminum oxide (Al₂O₃), and polyol ester. Specifically, the first coating layer 200 may include 10 wt. % to 15 wt. % of silver, 1 wt. % to 3 wt. % of boron nitride, 1 wt. % to 3 wt. % of zinc oxide, 20 wt. % to 27 wt. % of aluminum oxide, and 40 wt. % to 52 wt. % of polyol ester.

The first coating layer 200 may cool the inkjet print head 100 by absorbing heat generated in the inkjet print head 100, and minimize radpid changes in the viscosity of the ink stored inside the inkjet print head 100 by gradually radiating the absorbed heat into the air.

Results of a performance test of the inkjet print head assembly according to the present embodiment will be described with reference to FIGS. 2 through 6. For reference, Comparative Example 1 may indicate an inkjet print head assembly including only the inkjet print head, Comparative Example 2 may indicate an inkjet print head assembly in which an RTV is coated on the inkjet print head, and Example 1 may indicate the inkjet print head assembly according to the first embodiment of the present invention.

In addition, in FIGS. 2 and 3, a Y-axis indicates a size of liquid droplets, and an X-axis indicates a transfer distance of the inkjet print head assembly.

An LCD printing process may be reciprocally carried out by the inkjet print head. However, since an operation time of the inkjet print head is significanly increasaed in this printing process, considerable heat is generated in the inkjet print head to thereby change the viscosity of the ink. Accordingly, when the inkjet print head is continuously operated, the size of liquid droplets may be significantly larger than the initially set size thereof.

As shown in FIG. 2, in Comparative Example 1, deviation in the size of the liquid droplets between a printing operation of the inkjet print head in a forward direction and a printing operation thereof in a reverse direction is large. In particular, in Comparative Example 1, there is a disadvantage in that the inkjet print head is required to be reset to adjust the size of the liquid droplets after completing the printing opertion in the forward direction, in order that an increase in the size of the discharged liquid droplets due to the heating of the inkjet print head may be supressed.

In Comparative Example 2, the deviation in the size of the liquid droplets according to the printing operation in the forward direction and the printing operation in the reverse direction is relatively small. However, as described in Comparative Example 1, since this result could be obtained by cooling the inkjet print head or adjusting the setting of the size of the liquid droplets of the inkjet print head after completing the printing operation in the forward direction, there is a disadvantage in that operation speed efficiency of the inkjet print head is significanly decreased.

On the other hand, in Example 1, the deviation in the size of the liquid droplets according to the printing operation in the forward direction and the printing operation in the reverse direction is relatively stable, as shown in FIG. 2. That is, in Example 1, the first coating layer 200 rapidly absorbs the heat generated in the inkjet print head 100, and gradually radiates the absorbed heat outwardly, such that the deviation in the size of the liquid droplets according to the printing operation in the forward direction and the printing operation in the reverse direction may be minimized.

FIG. 3 is a graph illustrating a color coordinate deviation according to a transfer distance of the inkjet print head.

As shown in FIG. 3, the color coordinate deviation according to the transfer distance of the inkjet print head is relatively large and significantly unstable in Comparative Example 1; however, it is relatively stable in Comparative Example 2 and in Example 1. In particular, the color coordinate deviation in Example 1 is 0.5/1000, which is relatively smaller than 1.0/1000 of the color coordinate deviation in Comparative Example 2.

FIGS. 4 through 6 are graphs obtained by imaging heat distribution while the inkjet print head is operated.

As shown in FIG. 4, in Comparative Example 1, considerable heat is concentrated on an upper portion of an inkjet print head 300; however, heat radiation to the outside may be simultaneously carried out.

In the inkjet print head assembly according to

Comparative Example 1, the size of the liquid droplets may be increased when the temperature of the pressure chamber rises; however, since the cooling of the inkjet print head 300 is rapidly carried out, the deviation in the size of the liquid droplets is large.

In comparison, as shown in FIG. 5, in Comparative Example 2, an RTV 410 may cool heat generated in an inkjet print head 400 to a certain degree; however, since the RTV 410 may serve to block the heat from being radiated to the outside, it may fail to prevent the overheating of the inkjet print head 400.

Unlike this, as shown in FIG. 6, in Example 1, the first coating layer 200 absorbs the heat generated in the inkjet print head 200, and gradually radiates the absorbed heat, such that the printing quality of the inkjet print head 200 may be supressed from being rapidly changed.

Accordingly, the inkjet print head assembly according to the present embodiment may be effectively used in a process requiring considerable printing operation time and printing operation distance such as a large LCD printing operation, and excellent printing quality may be obtained even in such a process.

Hereinafter, another embodiment of the present invention will be described. For reference, in the following embodiments, the same components as those in the first embodiment may refer to the same refernece numerals as those in the first embodiment, and detailed descriptions thereof will be omitted.

An inkjet print head assembly 1000 according to a second embodiment of the present invention may further include a second coating layer 210 as shown in FIG. 7.

The second coating layer 210 may be formed on the first coating layer 200. For example, the second coating layer 210 may be formed between the inkjet print head 100 and the first coating layer 200, or formed on the top of the first coating layer 200.

The second coating layer 210 may include an RTV silicon. Alternatively, the second coating layer 210 may be formed of a compound having a compound component different from that of the first coating layer 200. Alternatively, the second coating layer 210 maybe formed of a compound having different amounts of components from those of the compound of the first coating layer 200.

For example, similar to the first coating layer 200, the second coating layer 210 maybe a compound including a metal powder, a compound including a polymer component, or a compound including an alcohol component.

In addition, the second coating layer 210 may be a compound including at least one of silver (Ag), boron nitride (B₃N₃), zinc oxide (ZnO), aluminum oxide (Al₂O₃), and polyol ester.

However, in the second coating layer 210, the content of silver or aluminum oxide among these components may be different from that of the first coating layer 200. Specifically, in the second coating layer 210, the content of silver or aluminum oxide may be relatively lower than that of the first coating layer 200.

Accordingly, the second coating layer 210 has a lower heat transfer efficiency than that of the first coating layer 200, so that the heat generated in the inkjet print head 100 may be suppressed from being rapidly radiated to the outside.

The inkjet print head assembly 1000 configured as above may gradually radiate the heat generated in the inkjet print head 100 through the first coating layer 200 and the second coating layer 210, such that the deviation in the size of the liquid droplets according to the operation time of the inkjet print head 100 may be minimized to thereby improve the printing quality.

Hereinafter, an inkjet print head assembly according to third and fourth embodiments of the present invention will be described with reference to FIGS. 9 and 10.

The coating layers 200 and 210 according to the embodiment of the present invention may be formed of a gel-type material which enables the coating layers 200 and 210 to be firmly attached to the inkjet print head 100, or a material which enables the coating layers 200 and 210 to be cured by W. However, the coating layers 200 and 210 may be formed of a liquid having a predetermined viscosity, as necessary.

Here, in the latter case (the coating layers 200 and 210 formed of the liquid), it is difficult to fix the coating layers 200 and 210 to the inkjet print head 100.

Taking this into consideration, in the third and fourth embodiments, a housing space 102 may be formed on the inkjet print head 100.

The housing space 102 may be formed on the first substrate 110 of the inkjet print head 100. Specifically, the housing space 102 may be formed in a portion on the first substrate 110 which corresponds to the pressure chamber 114.

The housing space 102 may be coated or applied with the material forming the first coating layer 200 or the second coating layer 210 to thereby absorb the heat generated in the pressure chamber or radiate the heat to the outside.

Meanwhile, as shown in FIG. 10, a partition wall 104 may be formed in the housing space 102. The partition wall 104 may partition the housing space 102 into a plurality of spaces, such that a phenomenon in which a liquid substance forming the coating layers 200 and 210 rolls in the housing space at the time of movement of the inkjet print head 100 may be reduced.

As set forth above, according to embodiments of the present invention, heat generated in an inkjet print head may be absorbed and radiated at a constant rate, so that deviations in the size of liquid droplets in accordance with a printing operation time may be significantly reduced.

Therefore, the printing quality of the inkjet print head may be improved.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head assembly, comprising:
an inkjet print head; and
a first coating layer formed on the inkjet print head, and absorbing and radiating heat generated in the inkjet print head.

2. The inkjet print head assembly of claim 1, wherein the first coating layer is formed of a compound including a metal powder.

3. The inkjet print head assembly of claim 1, wherein the first coating layer is formed of a compound including a polymer component.

4. The inkjet print head assembly of claim 1, wherein the first coating layer is formed of a compound including an alcohol component.

5. The inkjet print head assembly of claim 1, wherein the first coating layer is formed of a compound including at least one of silver (Ag), boron nitride (B₃N₃), zinc oxide (ZnO), aluminum oxide (Al₂O₃), and polyol ester.

6. The inkjet print head assembly of claim 1, wherein the first coating layer includes 10 wt. % to 15 wt. % of silver, 1 wt. % to 10 wt. % of boron nitride, 1 wt. % to 10 wt. % of zinc oxide, 22 wt.% to 27 wt. % of aluminum oxide, and 50 wt. % to 52 wt. % of polyol ester.

7. The inkjet print head assembly of claim 1, wherein the inkjet print head includes a housing space in which the first coating layer is housed.

8. The inkjet print head assembly of claim 7, wherein the housing space is partitioned by a plurality of partition walls.

9. The inkjet print head assembly of claim 1, wherein the inkjet print head includes:
a first substrate having a pressure chamber formed therein; and
a second substrate having a nozzle formed therein, the nozzle discharging ink stored in the pressure chamber.

10. The inkjet print head assembly of claim 9, wherein the first coating layer is formed on a surface of the first substrate.

11. An inkjet print head assembly, comprising:
an inkjet print head;
a first coating layer formed on the inkjet print head, and absorbing and radiating heat generated in the inkjet print head; and
a second coating layer formed on the first coating layer, and including a compound different from that of the first coating layer.

12. The inkjet print head assembly of claim 11, wherein the second coating layer is formed between the inkjet print head and the first coating layer.

13. The inkjet print head assembly of claim 11, wherein the second coating layer is formed of room temperature vulcanizing (RTV) silicon.

14. The inkjet print head assembly of claim 13, wherein the first coating layer is formed of a compound including a metal powder.

15. The inkjet print head assembly of claim 13, wherein the first coating layer is formed of a compound including a polymer componnet.

16. The inkjet print head assembly of claim 13, wherein the first coating layer is formed of a compound including an alcohol component.

17. The inkjet print head assembly of claim 13, wherein the first coating layer is formed of a compound including at least one of silver (Ag), boron nitride (B₃N₃), zinc oxide (ZnO), aluminum oxide (Al₂O₃), and polyol ester.

18. The inkjet print head assembly of claim 13, wherein the first coating layer includes 10 wt. % to 15 wt. % of silver, 1 wt. % to 10 wt. % of boron nitride, 1 wt. % to 10 wt. % of zinc oxide, 22 wt. % to 27 wt. % of aluminum oxide, and 50 wt. % to 52 wt. % of polyol ester.
